(19) United States
(12) Patent Application Publication
(10) Pub. No.: US 2016/0036792 A1
(43) Pub. Date: Feb. 4, 2016

(54) SYSTEMS, APPARATUS, AND METHODS FOR PRIVATE COMMUNICATION

(71) Applicant: Rhovo, LLC, Austin, TX (US)

(72) Inventor: Ryan Zacxhary Henning, Austin, TX (US)

(21) Appl. No.: 14/814,246

(22) Filed: Jul. 30, 2015

Related U.S. Application Data
(60) Provisional application No. 62/031,432, filed on Jul. 31, 2014.

(51) Int. Cl. H04L 29/06

(52) U.S. Cl. CPC H04L 63/0478; H04L 63/08; H04L 63/02

(57) ABSTRACT

Systems, apparatus, methods, etc. for private communications among trusted parties facilitated by untrusted parties. Methods are provided which comprise parameterizing a first cryptographic layer in a first peer and a corresponding layer in a second peer using a first cryptographic key. Such methods also comprise parameterizing a second cryptographic layer in the first peer and a corresponding layer in the second peer using a second cryptographic key. Methods of the current embodiment further comprise encrypting a message using the second and same cryptographic key (which differs from the first and same cryptographic parameter) and transmitting the message from the first peer whereby the second peer can decrypt the message using the second and same cryptographic key. If desired a facilitator server which is remote from the first peer facilitates peer discovery.

### CROSS REFERENCE TO RELATED APPLICATIONS

This application is a non-provisional application of U.S. provisional application No. 62/031,432 filed on Jul. 31, 2014 by Ryan Z. Henning and titled Method for Private Communication Among Trusted Peers Facilitated By Untrusted Parties which is incorporated herein as if set forth in its entirety.

### BACKGROUND

Malicious users can represent not just a nuisance but an outright threat to the well-being of many companies and/or individuals. For example, companies (and for that matter any organization) that rely on the Intern et or other wide area networks to communicate with their customers, vendors, government agencies, employers, etc. may, if they lack the proper technology and configuration, stand vulnerable to a vast variety of online security/hacking related threats such as theft of intellectual property and/or theft of private personnel data. The fact that often even large, well-established companies (and/or organizations) fail to employ the proper technology and configuration to protect their internal information reveals that doing so can be and often is non-trivial.

Furthermore, if even large organizations commonly fail to configure proper encryption technology for maintaining their privacy, it is all the more likely to be difficult for individuals (with far less resources) to protect their privacy in our modern connected, digital world. Theses individuals ought to be concerned with the configuration of systems they own, but ought to be weary of the often faulty systems/devices owned by third-party companies and organizations upon whom they rely to safeguard their digital information. These systems/devices include, but are not limited to, switches, routers, network address translators, internet service providers (ISPs), etc. But, these devices (and/or their owners) each allow (or could be acting as) so-called “men in the middle” waiting to intercept their information and put it to perhaps nefarious uses. While the use of firewalls, encryption, secure computing/communication protocols (for instance Hypertext Transfer Protocol Secure or HTTPS) can aid in fending off certain men in the middle attacks, the devices that the users rely on require access to the messages in order to route/handle them properly. Thus, the underlying information, which may contain private information, remains vulnerable at least in/to these untrusted devices and parties. The recent large-scale hack of the government's personnel databases, resulting in the leaking of personal information of an estimated 21 million employees, combined with other recent hacks on large companies like Sony highlight weaknesses in existing approaches to digital security.

### SUMMARY

The following presents a simplified summary in order to provide a basic understanding of some aspects of the disclosed subject matter. This summary is not an extensive overview of the disclosed subject matter, and is not intended to identify key/critical elements or to delineate the scope of such subject matter. A purpose of the summary is to present some concepts in a simplified form as a prelude to the more detailed disclosure that is presented herein. The current disclosure provides systems, apparatus, methods, etc. for private communications among trusted parties facilitated by untrusted parties.

Methods and systems disclosed herein will also specifically address how a individual can easily configure their devices to communicate privately amongst one another with the facilitation of third-party systems but in a why such that the third-party systems have no means to access the private information contained within the communications. The methods and systems disclosed herein also provide means for employing and configuring encryption-based systems that are both easy to configure yet provide strong privacy guarantees.

In accordance with embodiments, systems, apparatus, methods, etc. are provided which can make peer-to-peer (P2P) communications private. These systems can also make P2P communications possible in a wide variety of locations throughout the world. Further still, such systems can provide secure communications over networks (such as local area networks (LANs), wide area networks (WANs), the Internet, etc.) at higher speeds than heretofore possible.

Systems of embodiments work by creating secure communication channels between user devices over the internet and/or other telecommunications systems. User files are transferred directly from device to device using peer-to-peer (P2P) encryption schemes that makes it impracticable for any third party to decrypt the data involved including the devices, applications, users, etc. involved in setting up and/or facilitating such P2P communications. More specifically, systems of the current embodiment do not store user files on devices not owned by the users who wish to have P2P communications. Thus, these communications are secure against interception, manipulation, hacking, etc. by the facilitating systems of the current embodiment.

More specifically still, systems of embodiments maintain user privacy by separating user authentication and encryption key derivation. These systems maintain one password hash (computed by a function H1( )) which they use for user authentication. Separately, applications of the current embodiment (which are resident on user owned devices) use another, different encryption key (computed by a different function H2( ) as described further herein) that they use for P2P communications.

Note that it is not feasible to compute or otherwise determine the result of function H2( ) given only the result of the other function H1( ) and vice versa. Therefore, system components, non-authorized users, third parties, etc. (other than the user owned devices) cannot decrypt user P2P communications which are protected by the function H2( ), even if access is given to the H1( ) result.

To use the systems, new users often first register with the system. During registration, the new user chooses a username and password. An application resident on the user device (client-side and/or in the browser) hashes the password using the function H1( ). The application transmits the username and hashed password to a communications facilitation server. Thus, the facilitation server receives only the cryptographically-secure, one-way hashed password (hashed with function H1( )). Thus, the server is unable to decrypt or otherwise determine the user's original, un-hashed password.

At some point, the user will download a P2P communication application to the device to be authorized in accordance with embodiments. The user can then sign into the P2P application using their username and password. The P2P application hashes two instance of password, one instance with function H1( ) and the other instance with function H2( ). The P2P application transmits the username and the function H1( ) hashed password to the server for authentication. Note that the P2P application will use the function H2( ) applied to the user's password as an encryption key for P2P communications in accordance with the current embodiment. The facilitation server is never sent the result of H2( ), not even during registration even if registration is performed via a browser.

It might be helpful to note at this juncture that the facilitation server still does not know the user's password. It only receives the password as-hashed by function H1( ) and uses that data to authenticate the user/user's device. Again, it is not practicable for the facilitation server to obtain the result of the function H2( )-hashed password even given the other as-hashed password. It cannot, therefore, decrypt the P2P communications (which are encrypted using a key based on H2( ). Thus, even if the user lacks trust in the facilitation server (and/or devices, applications, components, users, etc. associated therewith), the user can trust the P2P communications which the facilitation server facilitates.

In some embodiments the two functions H1( ) and H2( ) are key derivation functions PBKDF2(Password-Based Key Derivation Function 2), computer over HMAC (hash message authentication code) over Whirlpool. Note also that in such embodiments, the functions H1( ) and H2( ) will differ in their salt values. Thereafter, once two or more user devices are authorized, they can begin communicating amongst themselves as further disclosed herein. Each user device will authenticate itself via the function H1( ). The P2P applications on the user devices will also prepare for P2P communications by, for instance, creating their secret encryption keys (via function H2( ) and the corresponding salt for that function).

Note also that, in accordance with the current embodiment, several types of encryption techniques can be employed in the various communications. For instance, during registration all communications between the client browser (on the user device(s)) and the facilitation server use SSL (Secure Sockets Layer) and/or TLS (Transport Layer Security) to protect the registration process. When the P2P applications on the user devices communicate with the facilitation server (for actions such as user/device authentication), it can be performed through RSA2048 (Rivest Shamir Aldeman 2048) and/or AES256 (Advanced Encryption Standard 256) protocols. Furthermore, in systems of embodiments, all P2P communications use AES256 protocols parameterized by the function H2( ) which is known only to user devices authorized in a particular group.

In some situations, firewalls, network address translators (NATs) and/or other communication obstacles might be present between the peer devices (controlled by a given user and/or system administrator) and for which secure P2P communication is still desired. Systems of embodiments provide robust data relay infrastructures such that even if the peer devices cannot communicate directly with one another (because of these obstacles), they can relay messages through the facilitation servers of embodiments. Moreover, they can do so without trusting the facilitation server while still enjoying secure communications facilitated by that server. And, as with their direct P2P communications, the relayed communications are encrypted via function H2( ) which (once again) remains unknown to the facilitation server and/or related entities. As a result, neither the facilitating server nor third parties can decrypt the contents of the relayed messages.

Systems of some embodiments, moreover, include peer discovery routines, algorithms, etc. The facilitation server of embodiments facilitates peer discovery activities which, as disclosed elsewhere herein, are cryptographically secure via function H1( ).

In accordance with embodiments, methods are also provided which comprise parameterizing a first cryptographic layer in a first computing device peer and a corresponding first cryptographic layer in a second computing device peer using a first and same cryptographic parameter. Such methods also comprise hashing a user's password via two distinct hashing functions H1( ) and H2( ). Methods of the current embodiment further comprise encrypting a message using a second and same cryptographic parameter and transmitting the encrypted message from the first peer toward the second peer. In these methods, the second peer can decrypt the encrypted message using the second and same cryptographic parameter wherein the second and first cryptographic parameters differ from one another.

In accordance with some embodiments, methods further comprise delivering the encrypted message to the second peer and/or using a facilitating server to parameterize the first cryptographic layers. Furthermore, in some methods the transmitting is over a wide area network; through a firewall; and/or through a local area network. If desired, a facilitating server which is remote from the first peer facilitates parameterization of the first cryptographic layer.

Various embodiments provide systems which comprise interfaces, memories, and processors in communication therewith and which perform methods further comprising parameterizing a first cryptographic layer in a first computing device peer and a corresponding first cryptographic layer in a second computing device peer using a first and same cryptographic parameter. Such methods also comprise hashing a user's password via two distinct hashing functions H1( ) and H2( ). Methods of the current embodiment further comprise encrypting a message using a second and same cryptographic parameter and transmitting the encrypted message from the first peer toward the second peer. In these methods, the second peer can decrypt the encrypted message using the second and same cryptographic parameter wherein the second and first cryptographic parameters differ from one another.

To the accomplishment of the foregoing and related ends, certain illustrative aspects are described herein in connection with the annexed figures. These aspects are indicative of various non-limiting ways in which the disclosed subject matter may be practiced, all of which are intended to be within the scope of the disclosed subject matter. Other advantages and novel features will become apparent from the following detailed disclosure when considered in conjunction with the figures and are also within the scope of the disclosure.

### BRIEF DESCRIPTION OF THE FIGURES

The detailed description is described with reference to the accompanying figures. In the figures, the left-most digit(s) of a reference number usually identifies the figure in which the reference number first appears. The use of the same reference numbers in different figures indicates similar or identical items.

FIG. 1 illustrates a system for trusted communications.

FIG. 2 illustrates a block diagram of an application for a server configured to facilitate trusted communications.

FIG. 3 illustrates a block diagram of an application for a peer computer configured to communicate in a trust worthy manner.

FIG. 4 illustrates a block diagram of an application for a peer computer configured to communicate in a trust worthy manner.

FIG. 5 illustrates a flowchart of a method for trusted communications.

FIG. 6 illustrates a flowchart of a method for configuring a system for trusted communications.

FIG. 7 illustrates a block diagram of a computing devices.

### DETAILED DESCRIPTION

This document discloses systems, apparatus, methods, etc. for private communications among trusted parties facilitated by untrusted parties.

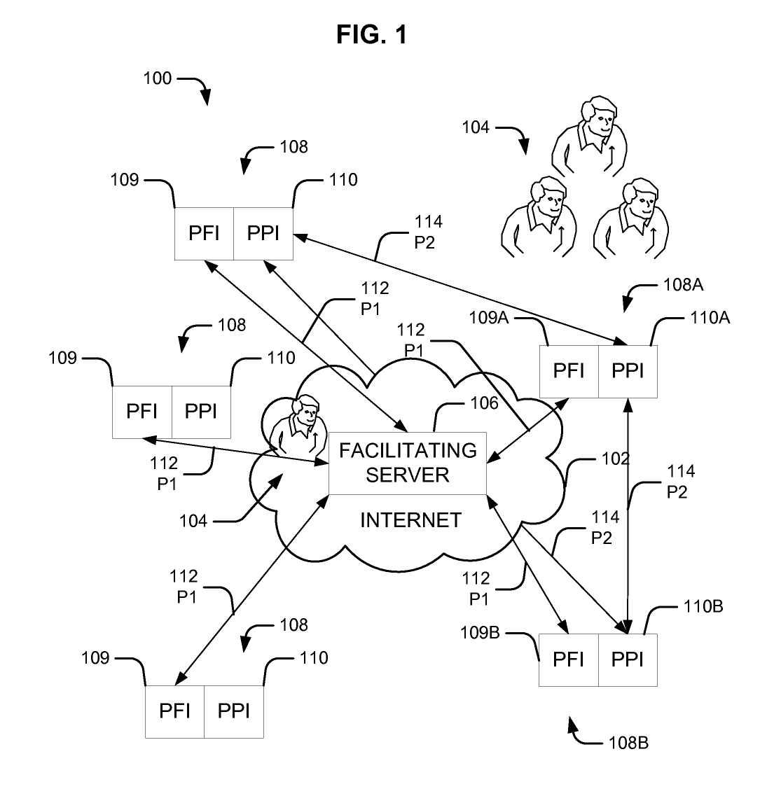

FIG. 1 illustrates a system for trusted communications. Generally, FIG. 1 illustrates a system for private communications among peer computing devices (hereinafter computers) which are facilitated by an untrusted party/device even in the presence of men in the middle and/or other threats to the privacy of those communications. More specifically, FIG. 1 illustrates a system 100, the Internet 102, men in the middle 104 and/or other privacy/security threats, a facilitating server 106, peer computers 108, peer/facilitator interfaces (PFI) 109, P2P interfaces (PPI) 110, control messages 112, data messages 114, and encryption keys P1 and P2.

The system 100 of the current embodiment comprises a facilitating server 106 and several peer computers 108 in communication with one another over the Internet 102, another WAN (Wide Area Network), a LAN (Local Area Network), and/or some other telecommunications system(s). The users of the system 100 might wish to communicate using the peer computers 108 which they typically control. However, for various practical reasons, they might choose to use an untrusted facilitating server 106 who is usually owned/controlled by some third party. As a result, passing communications through the untrusted facilitating server 106 could be expected to expose the communications to interception, tampering, copying, re-distribution, etc. by that facilitating server 106 as well as (perhaps) others. Indeed, a man in the middle 104 could somehow be associated with the facilitating server 106 (whether known to its owner or not). That man in the middle 104 could have infiltrated, “hacked,” or otherwise compromised the server for the purposes of intercepting messages from the users of the system. Despite these types of seeming vulnerabilities, the users can communicate securely via the system of the current embodiment even if their communications are facilitated by the untrusted facilitating server 106.

In order to do so, the facilitating server 106 is allowed to perform peer discovery (amongst/with the peer computers 108) and facilitate P2P communications between the same. More specifically, the peer computers 108 and facilitating server 106 exchange control messages 112 while the peer computers parameterize two layers of encryption. And, using those two (or more) layers of encryption, the peer computers 108 communicate with one another and/or the facilitating server 106. Those layers of encryption are parameterized in both/all peer computers 108 at some time such as during peer discovery.

The first layer of encryption is parameterized by encryption key P1 and is used to protect the control messages exchanged between the facilitating server 106 and the peer computers 108. Encryption key P1 is either the result of H1( ) as disclosed elsewhere herein, or the encryption key P1 is the result of a negotiation between facilitating server 106 and computer 108 using a method such as RSA. The second layer of encryption is parameterized by encryption key P2 to encrypt/decrypt the data messages 114 which they exchange with one another in a P2P manner (with/without intermediaries there between). Moreover, only the peer computers 108 possess encryption key P2 which is based on the result of the function H2( ). as disclosed elsewhere herein. Indeed, the facilitating server 106 of the current embodiment does not know nor can it derive the P2P encryption key P2 even given the encryption key P1. Moreover, should a peer computer 108 need to relay a message through the facilitating server 106 to another peer computer 108, it first encrypts the data message 114 (to be relayed) with the encryption key P2 and then passes it through an encryption layer that is parameterized by cryptographic key P1.

Thus, these P2P messages are encrypted with two keys: the encryption key P2 and the encryption key P1. Only the peer computers 108 know both keys and can therefore doubly decrypt the message to retrieve its contents. In this scenario, the recipient/hosting peer computer 108 decrypts the entire relay message using P1 to yield decrypted header information and a still encrypted (with P2P encryption key P2) message payload. But, the recipient peer computer 108 also knows the P2P encryption key P2 and can therefore decrypt the payload as well using the encryption key P2. Note also that since the facilitating server 106 (in the current embodiment) only knows P1, it can only decrypt the message to the extent that it is protected by P1. As a result, the facilitating server 106 can (at most) examine the header information and route the partially decrypted message to its intended destination with the payload still protected by P2P encryption key P2.

With continuing reference to FIG. 1, the peer computers 108 of the current embodiment each comprise two subsystems: a peer/facilitator interface (PFI) 109 and a P2P interface (PPI) 110. The PFI 109 is configured to exchange control messages 112 (and to relay messages) with the facilitating server 106 while the PPI 110 is configured to exchange data messages 114 with other peer computers 108 via their PPIs 110. Note also that both the PFI 109 and PPI 110 of a peer computer 108 are configured to decrypt received messages and forward them to other subsystems, modules, applications, routines, etc. resident on the peer computers 108 and to receive messages from these other subsystems, encrypt them, and route them to either the facilitating server 106 or the intended other peer computer 108. Note that the information transferred via system 100 via the data messages 114 (and/or relayed messages) can be any type of information. For instance, the information can be a file or files, email messages, simple text messages, multimedia data, etc.

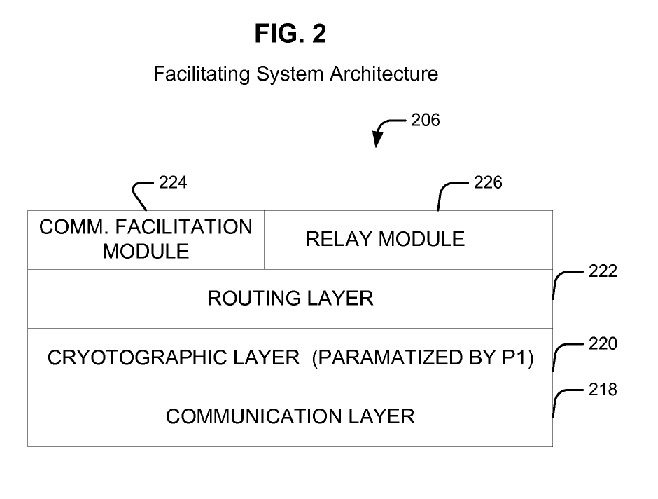

FIG. 2 illustrates an application for a server configured to facilitate trusted communications. In general, FIG. 2 illustrates the architecture of a communications facilitation application residing in a server of embodiments. The application performs peer “finding,” identification, etc. and can serve as a message relay device should P2P communications become unavailable for some reason. The facilitator application 206 comprises a communication layer 218, a cryptographic layer 220, a routing layer 222, a facilitation module 224, and a data relay module 226.

The facilitation module 224 handles a variety of activities related to peer arrivals/departures to/from systems 100 of embodiments. For instance, it responds to messages from newly arrived peers by establishing certain functionality within the facilitation module 224 for it to communicate with (and to coordinate) the activities of the newly arrived peer. In the current scenario, it also notifies other, existing peers of the presence of the new peer and informs the new peer of the presence and identity of the existing peers. The facilitation module 224 of the facilitator application 206 also responds to messages from peers as they depart the system by gracefully terminating communications with them and informing other, remaining peers of the departure of the particular peer(s). The peer computers 108 can then also gracefully terminate communications with departed peers.

The facilitation module 224 also performs activities associated with establishing P2P communication channels and failures related thereto. For instance, if a peer reports that it was able to establish a connection with another peer, the facilitation module 224 informs the peers involved that they can begin communicating with one another directly. But, should a peer report a failure to establish such a connection, the facilitation module 224 informs the involved peers to terminate the failed attempt to connect.

On that note, and with continuing reference to FIG. 2, the relay module 226 can be used to recover from failed connection attempts. In some situations, a peer that experiences a failed connection can request that the facilitator application 206 relay messages between it and the other involved peer(s). The relay module 226 can, if desired, configure the facilitator application 206 and/or the involved peers for message relays or at least assist in such activities.

As to the other portions of the facilitator application 206, they generally handle communications with the various peers as is disclosed further herein. For instance, the routing layer 222 routes incoming message to the facilitation module 224 and/or relay module 226 responsive to the type of the received message. For outbound messages, it directs them toward the intended peer recipient.

With ongoing reference to FIG. 2, the cryptograph layer 220 performs cryptograph functions for the facilitator application 206 and/or its component parts. Thus, it performs both encryption and decryption associated with incoming and outgoing messages. And more particularly, it does so in relationship to the encryption key P1 used by the peers such that the facilitator application 206 can communicate with them even if it is unable to decrypt the payloads of the peer messages it receives. For its part, the communication layer 218 of the facilitator application 206 handles activities associated with the sending/receiving of messages between the facilitator application 206 (or facilitator 106) and the various peers. Thus, the communication layer 218 can be considered to include functions typically handled at (or in association with) network interface cards in computers/servers in which such technology is employed for transmitting/receiving information from various computer networks such as a private LAN, a public WAN, the Internet, etc.

Note that messages flow up/down (in a hierarchal sense) through the facilitator application 206. Thus, for outbound messages, either the facilitation module 224 or data relay module 226 will initiate the outbound message and hand it off to the routing layer 222. The routing layer 222 will receive that outbound message and identify which peer it should sent to. It will also forward the message to the cryptographic layer 220 along with the still unencrypted header and with the identification of the intended recipient for the message. The cryptographic layer 220 will encrypt the entire message (including both the payload and header) using the encryption key P1 and forward it to the communication layer 218 along with the recipient's identity/address. The communication layer 218 of the current embodiment transmits the as-encrypted message to the intended recipient. See FIGS. 1 and 2.

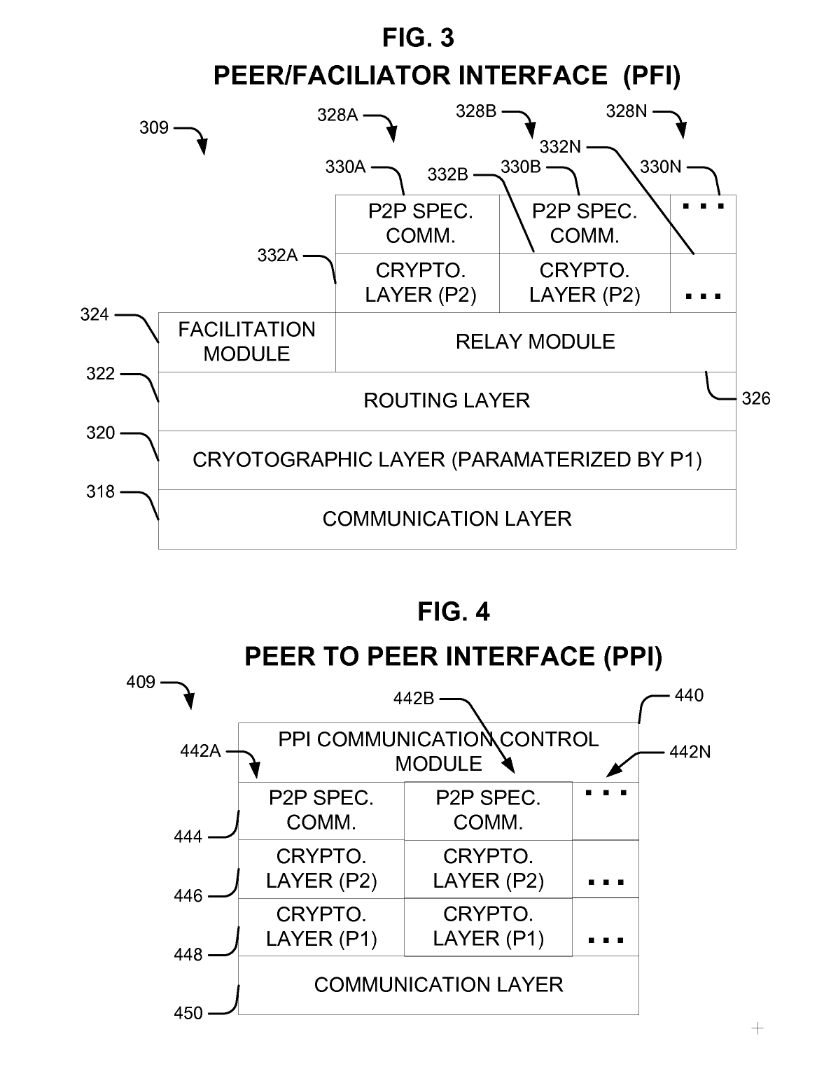

FIG. 3 illustrates a block diagram of an application for a peer computer configured to communicate in a trust worthy manner. Generally, the application or peer facilitator interface (PFI) shown by FIG. 3 handles communications with a facilitating server 106 for a particular peer computer 108 in which it resides. More specifically, FIG. 3 illustrates the PFI 309, a communication layer 318, a cryptographic layer 320, a routing layer 322, a facilitation module 324, and one or more P2P specific connections 328A, 328B, to 328N and their corresponding application-specific modules 330A, 330B, to 330N and corresponding cryptographic layers 332A, 332B to 332N. In some scenarios, though, no P2P specific connections 328 might be present in a particular peer computer (at particular times) without departing from the scope of the current disclosure.

In the current embodiment, the PFI 309 performs at least two types of activities First, the current embodiment, though, the PFIs 309 handle peer discovery/departure activities in conjunction with the facilitator 106. Secondly, it handles P2P message relays in conjunction with the facilitating server 106 should message relaying become desirable. Otherwise, the peer computers 108 typically communicate directly with one another via their PPIs 110.

The facilitation module 324 resident in the peer computer 108 manages the other layers/modules in the PPI 309. More specifically, it examines messages from the facilitating server 106 and determines: 1) when to initiate its own network discovery, 2) whether its network discovery was successful, 3) whether to begin P2P communications, 4) whether to request message relaying if not, and 5) whether to depart from the network. In so doing, it directs/orchestrates other layers/modules of the peer PFI 309 in the performance of their activities.

It might be helpful to note that most of the various layers/modules of the PFI 309 of the current embodiment perform certain discrete activities and pass the results thereof to the layers/modules above/below themselves as the direction of communication involved suggests. Of course, the terms “above” and “below” as used herein do not imply any orientation of these layers/modules. Rather, these terms are used as a matter of convenience and are thus non-limiting. Nor is it necessary that these activities be discrete. Rather, they could be programmed into one (or more) entities without departing from the scope of the disclosure. Note that the same comments are true of the various layers/modules resident on the peer computers 108 and/or the facilitator application 206.

With ongoing reference to FIG. 3, the communication layer 318 handles the details of transmitting/receiving messages to/from the peer computers 108. Thus, the communication layer 318 can be considered to include functions typically handled at (or in association with) network interface cards in computers/servers in which such technology is employed. Note also that, in the current embodiment, most P2P messages will transit and/or be processed by the communications layer 318 and then be transported over some sort of network. That network might be a private LAN, a public WAN, the Internet etc. But, as is disclosed herein, these messages are encrypted with encryption key P2 which is known only to the peer computers 108 and no one else (even the facilitator 106) in the current embodiment.

The cryptographic layer 320 of the current embodiment encrypts/decrypts these messages with encryption key P1. Note that the cryptographic layer 320 encrypts/decrypts the entire message which it receives whether from a peer computer 108 (via the communication layer 318) or from the routing layer 322. Thus, if a portion of a message, for instance, the payload (or data containing portion) is already encrypted, the cryptographic layer applies a second encryption to that already encrypted portion. The remaining, unencrypted portion (for instance the header portion) of the message is encrypted by the encryption layer 320.

Thus, should the payload of a message be encrypted with encryption key P2, even the facilitating server 106 cannot decrypt it or otherwise access the data therein (absent possession of the encryption key P2 with which that portion of the message was encrypted). Indeed, in the current embodiment, the only portion of the messages transiting layers/modules above the cryptographic layer 320 which are not encrypted (with encryption key P2) are the header portions of those messages. The facilitator 106, the machine in which it resides, the users/administrators associated with that machine, etc., therefore cannot access the P2 encrypted message payloads. They can, though, decrypt the message headers of received messages thereby enabling the routing of these messages to their corresponding destinations.

With continuing reference to FIG. 3, routing layer 322 performs functions related to routing messages to/from the P2P specific connections 328. In one direction, it receives messages from the relay module 326, reads the unencrypted header information and routes the message through the cryptographic layer 320 and the communication layer 318 to the peer computer 108 for delivery to the same and/or its user. In the other direction, it receives messages with their headers decrypted from the cryptographic layer 320 and reads those headers. It then routes the message (with its payload still encrypted) to one or more of the P2P specific connections 328 corresponding to the intended recipients identified in the headers, via the relay module 326.

The P2P specific modules 328 perform cryptographic operations and communication functions on those messages relayed/routed through them. More specifically, when message relaying is called for, the relay module 326 (of the peer) routes outbound messages (originating from a P2P specific module 328), intended for relay through the facilitator 106 down through layers 322, 320, and 318. Thus, for a particular message from one particular peer computer 108 to be relayed to another particular peer computer 108, the corresponding cryptographic layer 332A applies encryption key P2 to it. In accordance with the current embodiment, that encryption key P2 is known to the peer computers 108 (but not the facilitator 106) thereby preventing the facilitating server 106 from decrypting the message contents. However, the encryption key P1 applied by cryptographic layer 320 is known to the facilitating server 106 of embodiments. Such features allow the facilitating server 106 to decrypt the header/routing information in the message, but, not the message payload which the cryptographic layer 332A encrypted with encryption key P2.

The P2P specific communication layer 330A is the source and destination of messages from and/or to a specific other computer 108. These messages are relayed (via the facilitator 106) over some telecommunications network (which might be public or private). The facilitating server 106 partially decrypts such messages using the applicable encryption key P1, extracts the routing information therefrom, and routes the message to/from the intended peer computer 108.

For incoming (and relayed) messages, the P2P specific communication layer 318 (of the receiving peer computer 108) receives the message from the network over which the facilitating server 106 routed it (or over which it otherwise traveled). It passes the received message on to the first cryptographic layer 320. The P2P specific cryptographic layer 320 decrypts the message using encryption key P1. It also passes the (partially) decrypted (and relayed) message to the routing layer 322 which sends it on to the second cryptographic layer 332B for decryption using the encryption key P2. The (entirely) decrypted message is sent from the second cryptographic layer 332B to the application-specific module 330B which delivers it to an application in the peer computer 108 for storage, display, further processing in accordance with user desires, pre-programmed instructions, etc.

A few words might be in order regarding the origin of encryption keys P1 and P2 which systems of embodiments use to protect both control messages and relay messages being exchanged by the facilitating server 106 and the peer computers 108. Encryption key P is either the result of function H1( ) applied to the user's password or is a value negotiated by the facilitating server 106 and each peer computer 108 using a method such as RSA. The encryption key P2 is, in the current embodiment moreover, based on the result of H2( ) applied to the user's password or other shared information.

FIG. 4 illustrates a block diagram of an application for a peer computer configured to communicate in a trust worthy manner. Generally, FIG. 4 illustrates a P2P interface resident in/on a particular peer computer 108 which enables the peer computer 108 to communicate directly with its peers (and to do so in a trust worthy manner). More specifically, FIG. 4 illustrates a control module 440, P2P specific connections 442A, 442B, to 442N, application-specific modules 444A, 444B to 444N, cryptographic layers 446A, 446B, to 446N, cryptographic layers 448A, 448B to 448N, and network communication layer 450. As disclosed elsewhere herein, for direct P2P communications, the peers each establish P2P specific connections 442 corresponding to the other peers that have entered the system (and not yet departed). Of course, the control module 440 directs/orchestrates the activities of the various modules/layers in the PPI 409 during these activities.

Each P2P specific connection 442 of a particular peer comprises a application-specific module 444, cryptographic layers 446 and 448, and an established connection over a computer network (e.g. a private LAN, a public WAN, the Internetn, etc.) using the networking communications layer 450. When an incoming message is received, it is received via its established connection using network layer 450 to the peer that sent the message. The network layer 450 receives the message and passes it to the corresponding cryptographic layer 448. This layer decrypts the message with the encryption key P1 rendering the header information accessible to the PPI 409. The cryptographic layer 448 passes the (partially) decrypted message to the cryptographic layer 446 where it is decrypted using encryption key P2. The resulting and (fully) decrypted message is passed to the application-specific module 444 for delivery to the peer computer 108 (and/or applications resident thereon) for display, storage, etc.

When a peer computer 108 sends a message to another peer directly (rather than relaying it through the facilitator), the message originates in the application-specific module 444 or an application in communication with and/or associated therewith. The message is passed to cryptographic layer 446 for the payload to be encrypted by encryption key P2, then is passed to cryptographic layer 448 for the headers to be encrypted by encryption key P1. The network communication layer 450 transmits the doubly encrypted message to the intended recipient peer computer 108 directly via some network (LAN, WAN, the Internet, etc.). Thus, whether messages are inbound or outbound, the only entities capable of accessing the data in the payloads are those that know both the encryption keys P1 and P2. And, in accordance with the current embodiment, those entities are only the peer computers 108 assuming users associated with the peer computers 108 maintain the secrecy thereof. As an alternate embodiment, the cryptographic layer 448 may be omitted from systems of embodiments while letting cryptographic layer 446 handle encrypting the message header using P2 and doing so is not expected to compromise the privacy of the system.

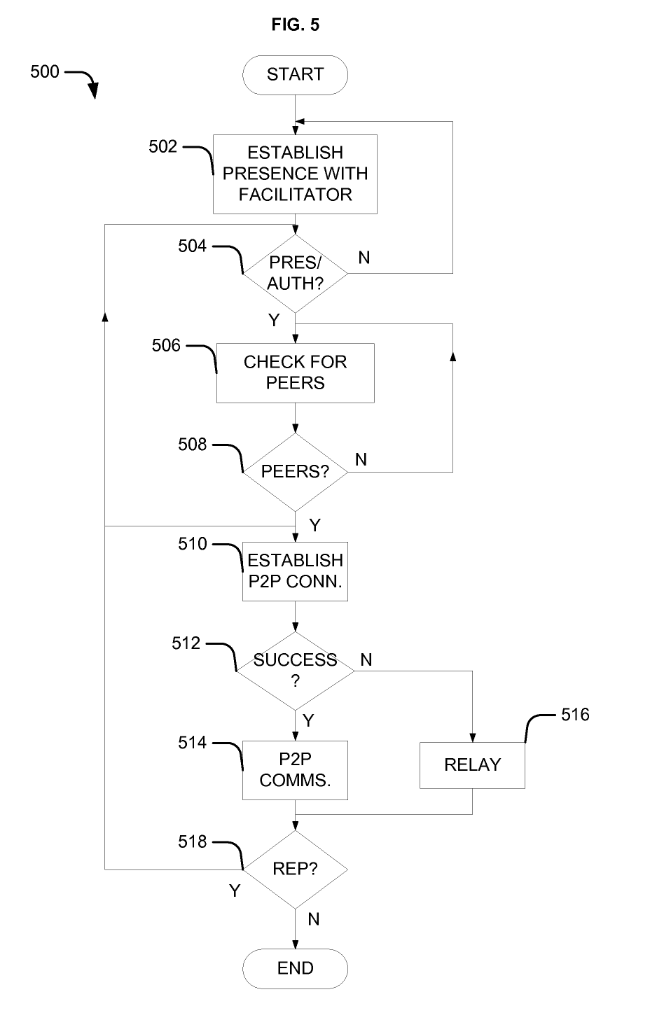

FIG. 5 illustrates a flowchart of a method for trusted communications. In accordance with embodiments, the method 500 includes various activities such as a user device (i.e., a peer) establishing its presence in a system (such as system 100) with the facilitating server (such as facilitating server 106). See reference 502. Note that a peer computer 108 (or other user device) can do so by sending the facilitating server 106 the username and a corresponding hashed password (i.e., the result of function H1( )). The facilitating server 106 can use that information to authenticate the incoming request for participation in the system 100 by comparing the received, hashed password with the hashed password stored in its memory during registration. Note that the facilitating server 106 need not know the original password (i.e., the input to function H1( ) and H2( )). Rather, it can compared the previously stored hashed password with the one it receives during the communication request to authenticate the requesting user device.

If the facilitating server 106 authenticates the peer computer 108 (see reference 504), it returns a message to that peer computer 108 to indicate that it is now considered to be present in the system. Furthermore, the facilitating server 106 can send the peer computer 108 a list of other peer computers 108 present in the system 100. And, of course, the facilitating server 106 can send further messages to the other peer computers 108 in the system 100 updating the list of peers present in the system 100. Accordingly, the peer computer 108 can determine whether other peers are present in the system. See references 506 and 508.

If peers are present, the peer computer 108 can send a connection request to the facilitator 106. The facilitating server 106 can notify that other peer computer 108 to connect with the requesting peer computer 108 through a network connection shareable between the requesting device and the requested device. Often, that network connection will be via a LAN. But, it need not be so. Indeed, it could be via a WAN, a telecommunications system, etc. Reference 510 illustrates such P2P connection activities. Note that if the connection fails for some reason such as an inability of the connection to cross a firewall, failure to navigate a NAT, etc., then message relaying can be initiated.

With continuing reference to FIG. 5, reference 512 illustrates that if the connection is successful, the peer computer 108 can begin P2P communications via the newly established shared network connection. Moreover, it can do so while trusting the protection provided via encryption key P2 even if it distrusts the facilitator 106. See reference 514. If not, or if for some reason direct P2P communications are not desired, then reference 512 illustrates that the peer computer 108 can instead request that the facilitating server 106 relay messages between it and another peer computer 108. See reference 516. Again, the peer can trust the protection provided via encryption key P2 since the facilitating server 106 would not know encryption key P2.

Furthermore, FIG. 5 also illustrates that method 500 can be repeated in whole or in part. For instance, the peer computer 108 could loop back to reference 510 and establish another P2P connection with a different (or the same) peer computer 108. And, of course, other peer computers 108 could initiate P2P connections with it. Furthermore, the peer computer 108 could loop back to reference 506 and check for the arrival of new peers in the system 100 and/or for the departure of previously present peers. Of course, method 500 could be performed with fewer or more operations, different operations, operations in differing orders, etc. without departing from the scope of the current disclosure.

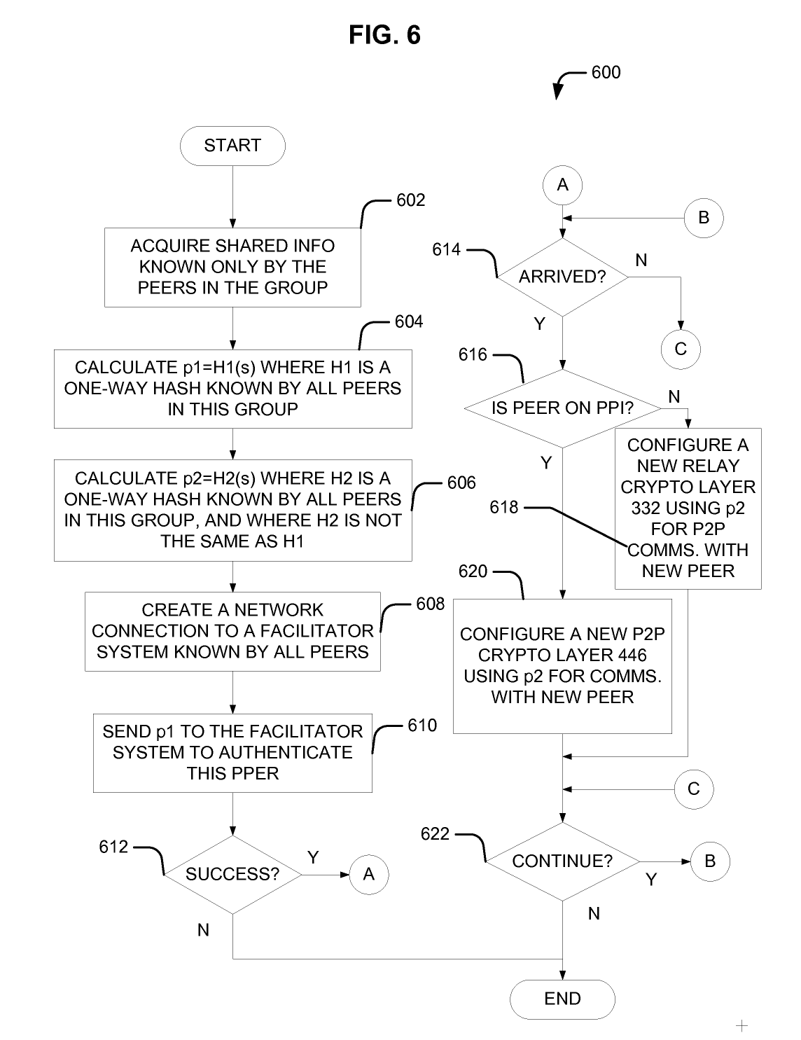

FIG. 6 illustrates a flowchart of a method for configuring a system for trusted communications. The method 600 comprises various activities such as a system administrator (for a group of peer computers 108) acquiring or creating a shared information “s” for use with the two cryptographic functions to be used in a particular communications system 100. The system administrator (of course) can provide this shared information to the various peer computers and/or to only those users to be associated with a desired P2P group. See reference 602. Note that a common embodiment of this shared information is a password or passphrase provided by the user to each device, but the shared information could be any digital data somehow obtained by each peer computer 108 in a given group. That is, it is same for all peers and if used in some cryptographic function H1( ) or H2( ) for instance, results in the same cryptographic parameter for that cryptographic function H1( ) or H2( ) respectively.

Method 600 also includes the various peers parameterizing a first layer of encryption (for use with communications between themselves and the facilitating server) with a first encryption key P1. They can do so by calculating this first parameter using the function H1( ). See reference 604. Again, it will be the same for all peers involved.

In accordance with the current embodiment, the peers can also parameterize a second and same encryption layer for use during P2P communications. See reference 606. They can do so by calculating a second encryption key P2 using the function H2( ) and the shared information. The encryption key P2 will be the same for all peers but will differ from the encryption key P1 because it was determined using a different encryption function than that used to derive the encryption key P1. As disclosed elsewhere herein, the cryptographic functions H1( ) and H2( ) differ from one another and are known (or shared with) all peers to be included in the P2P group. Note also that both cryptographic functions H1( ) and H2( ) are known to all peers to be included in that group. Indeed, a system administrator can provide all of those peers with the functions H1( ) and H2( ) as well as the shared information s. Moreover, typically, the system administrator will take steps to prevent such information from leaving and/or leaking from the intended P2P group.

At some point a peer computer 108, peer, a particular user, etc. might wish to participate in the communications system 100 of the current embodiment. That user can direct the peer computer 108, application resident thereon, peer, etc. to contact the facilitating server 106 and to attempt to establish a connection therewith. That facilitating server 106 can be known to all of the peers which are intended to be included in the P2P group. See reference 608.

Furthermore, as disclosed elsewhere herein, the encryption key P1 can be the result of function H1( ) applied to shared information (typically a user's password) as indicated at reference 610. The resulting value, or course, can be shared with the facilitating server 106 during registration and is therefore know to the facilitating server 106 of embodiments. As a result, the facilitating server 106 can authenticate the peer (who might be requesting a connection) by comparing the encryption key P1 the peer sends and the version of the encryption key P1 which the facilitating server 106 previously stored in its memory.

Reference 612 illustrates that if the authentication via the first encryption key P1 fails, then method 600 can end. If the authentication of the peer succeeds, then the facilitating server 106 can determine that the requesting peer has “arrived” in the system and add it to a list of peers present in the system 100. The change to the list of present peers can be published to the peers already in the system and can be provided to subsequently arriving peers. Of course should a peer depart the system 100 (as indicated by a departure message from that peer), the list of present peers can be updated and distributed accordingly.

With ongoing reference to FIG. 6, thus, the various peers present in the system 100 can determine whether other peers appear in the system 100 via the list of peers present in the system 100 as distributed by the facilitator 106. See reference 614. If no peer has recently arrived in the system, then the peer can continue its activities as desired (see reference 622). On the other hand, if another peer has recently arrived in the system 100, then the peer can check to see if it can be contacted through its PPI 409 as indicated at reference 616. If not, then the peer can configure a new cryptographic layer 332 using encryption key P2 for facilitator-based message relaying to/from the newly arrived peer. See reference 618.

However, and with continuing reference to FIG. 6, if the recently arrived peer can be contacted through its PPI 409, then the peer can establish a different cryptographic layer 446 using encryption key P2 for use in direct P2P communications with the recently arrived peer. See reference 620. Thus, in both of the foregoing cases, the only entities that can decrypt the exchanged messages (or those to be exchanged) are those that know or can calculate the encryption key P2, which, as described elsewhere herein, are only known to the peers in a group; the facilitator does not know the encryption key P2.

Of course, in either case, the peer can determine whether it should continue with method 600 by checking for user input one way or the other. If the user desires to end the method (and informs the peer accordingly), the method 600 can terminate as illustrated by reference 622. Otherwise, the peer can continue performing method 600 by returning to reference 614 or some other reference illustrated by FIG. 6. Note, though, that method 600 need not include all activities illustrated by FIG. 6 and/or could include other activities. Moreover, method 600 could be practiced in a different order all without departing from the scope of the disclosure.

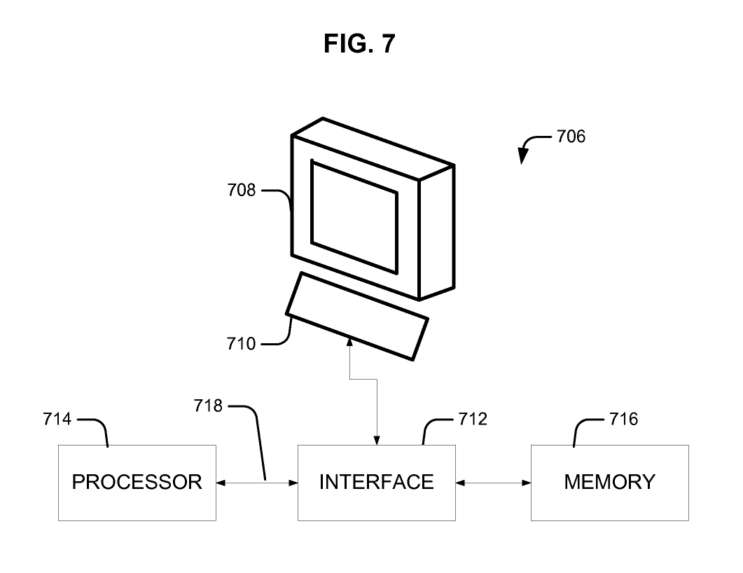

FIG. 7 illustrates a block diagram of a computing device. Such computers can be used to implement the user devices, peer computers, facilitating servers, and/or other computing devices disclosed herein. Thus, a peer can be implemented on such a computer and a facilitating server can be implemented on another such a computer (or even the same one). However, those skilled in the art will understand that the particular architecture illustrated by FIG. 7 is not limiting. And, indeed, many architectures would suffice to implement the devices disclosed herein. For instance, personal computers, laptop computers, tablets, mobile devices (such as Apple iPhones, Android cellular telephones, etc.), virtualized hardware as well as others could be used to implement the devices disclosed herein.

Still with reference to FIG. 7, a few words might be in order about the computer(s) 706 and/or other systems, apparatus, etc. used to host various applications, programs, routines, etc. disclosed herein. The type of computer 706 used for such purposes does not limit the scope of the disclosure but certainly includes those now known as well as those which will arise in the future. But usually, these computers 706 will include some type of display 708, keyboard 710, interface 712, processor 714, memory 716, and bus 718.

Indeed, any type of human-machine interface (as illustrated by display 708 and keyboard 710) will do so long as it allows some or all of the human interactions with the computer 706 as disclosed elsewhere herein. Similarly, the interface 712 can be a network interface card (NIC), a WiFi transceiver, an Ethernet interface, etc. allowing various components of computer 706 to communicate with each other and/or other devices. The computer 706, though, could be a stand-alone device without departing from the scope of the current disclosure.

Moreover, while FIG. 7 illustrates that the computer 706 includes a processor 714, the computer 706 might include some other type of device for performing methods disclosed herein. For instance, the computer 706 could include a microprocessor, an ASIC (Application Specific Integrated Circuit), a RISC (Reduced Instruction Set IC), a neural network, etc. instead of, or in addition, to the processor 714. Thus, the device used to perform the methods disclosed herein is not limiting.

Again with reference to FIG. 7, the memory 716 can be any type of memory currently available or that might arise in the future. For instance, the memory 716 could be a hard drive, a ROM (Read Only Memory), a RAM (Random Access Memory), flash memory, a CD (Compact Disc), etc. or a combination thereof. No matter its form, in the current embodiment, the memory 716 stores instructions which enable the processor 714 (or other device) to perform at least some of the methods disclosed herein as well as (perhaps) others. The memory 716 of the current embodiment also stores data pertaining to such methods, user inputs thereto, outputs thereof, etc. At least some of the various components of the computer 706 can communicate over any type of bus 718 enabling their operations in some or all of the methods disclosed herein. Such buses include, without limitation, SCSI (Small Computer System Interface), ISA (Industry Standard Architecture), EISA (Extended Industry Standard Architecture), etc., buses or a combination thereof. With that having been said, it might be useful to now consider some aspects of the disclosed subject matter.

### CONCLUSION

Although the subject matter has been disclosed in language specific to structural features and/or methodological acts, it is to be understood that the subject matter defined in the appended claims is not necessarily limited to the specific features or acts disclosed above. Rather, the specific features and acts described herein are disclosed as illustrative implementations of the claims.

1. A method comprising:
parameterizing a first cryptographic layer in a first computing device peer and a corresponding first cryptographic layer in a second computing device peer using a first and same cryptographic key on a shared piece of information;
parameterizing a second cryptographic layer in the first computing device peer and a corresponding second cryptographic layer in the second computing device peer using a second and same cryptographic key on the shared piece of information;
allowing a facilitating server to authenticate the user using the shared piece of information as parameterized by the first and same cryptographic key wherein the second and first cryptographic keys differ from one another; and
transmitting a message from the first peer toward the second peer whereby the second peer to decrypt the encrypted message using the second and same cryptographic parameter.

2. The method of claim 1 further comprising delivering the encrypted message to the second peer.

3. The method of claim 1 further comprising using a facilitating server to facilitate peer discovery.

4. The method of claim 1 further comprising the transmitting being over a wide area network.

5. The method of claim 1 further comprising the transmitting being through at least one firewall.

6. The method of claim 1 further comprising the transmitting being through a local area network.

7. The method of claim 1 wherein a facilitator server remote from the first peer facilitates the parameterizing of the first cryptographic layers.

8. A method comprising:
allowing a first cryptographic layer in a first computing device peer and a corresponding first cryptographic layer in a second computing device peer to be parameterized using a first and same cryptographic key on a shared piece of information;
allowing a second cryptographic layer in the first computing device peer and a corresponding second cryptographic layer in the second computing device peer to be parameterized using a second and same cryptographic key on the shared piece of information;
authenticating the user using the using the shared piece of information as parameterized by the first and same cryptographic key wherein the second and first cryptographic keys differ from one another;
allowing a message to be encrypted using the second and same cryptographic key wherein the second and first cryptographic keys differ from one another; and
allowing the encrypted message to be transmitted from the first peer toward the second peer whereby the second peer to decrypt the encrypted message using the second and same cryptographic key.

9. The method of claim 8 further comprising allowing the encrypted message to be delivered to the second peer.

10. The method of claim 8 further comprising using a facilitating server to facilitate peer discovery.

11. The method of claim 8 further comprising the transmitting to be over a wide area network.

12. The method of claim 8 further comprising the transmitting to be through at least one firewall.

13. The method of claim 8 further comprising the transmitting to be through a local area network.

14. The method of claim 8 wherein a facilitator server remote from the first peer facilitates the parameterizing of the first cryptographic layers.

15. A system comprising:
a memory;
an interface; and
a processor in communication with the memory and the interface, the memory storing processor executable instructions which when executed by the processor cause the processor to perform a method further comprising,
allowing a first cryptographic layer in a first computing device peer and a corresponding first cryptographic layer in a second computing device peer to be parameterized using a first and same cryptographic key on a shared piece of information,
allowing a second cryptographic layer in the first computing device peer and a corresponding second cryptographic layer in the second computing device peer to be parameterized using a second and same cryptographic key on the shared piece of information,
authenticating the user using the using the shared piece of information as parameterized by the first and same cryptographic key wherein the second and first cryptographic keys differ from one another,
allowing a message to be encrypted using the second and same cryptographic key wherein the second and first cryptographic keys differ from one another, and
allowing the encrypted message to be transmitted from the first peer toward the second peer whereby the second peer to decrypt the encrypted message using the second and same cryptographic key.

16. The system of claim 15 wherein the method further comprises allowing the encrypted message to be delivered to the second peer.

17. The system of claim 15 wherein the method further comprises using a facilitating server to facilitate peer discovery.

18. The system of claim 15 wherein the transmitting to be over a wide area network.

19. The system of claim 15 wherein the transmitting to be through at least one firewall.

20. The system of claim 15 wherein a facilitator server remote from the first peer facilitates the parameterizing of the first cryptographic layers.
